(19) United States
(12) Patent Application Publication
(10) Pub. No.: US 2020/0200718 A1
(43) Pub. Date: Jun. 25, 2020

(54) COLUMN HANDLING IN CHROMATOGRAPHY

(71) Applicant: Arugadoss Devakumar, Oceanside, CA (US)

(72) Inventor: Arugadoss Devakumar, Oceanside, CA (US)

(21) Appl. No.: 16/280,036

(22) Filed: Feb. 20, 2019

Related U.S. Application Data
(60) Provisional application No. 62/782,223, filed on Dec. 19, 2018.

(51) Int. Cl. G01N 30/60

(52) U.S. Cl. CPC G01N 30/6047; G01N 2030/027

(57) ABSTRACT

Laboratory workflow efficiency is improved by providing convenient and accessible storage for columns and accessories used in high performance liquid chromatography.

### CROSS REFERENCE TO RELATED APPLICATION

This application claims priority from U.S. Provisional Patent Application No. 62/782,223, entitled “HPLC-UPLC Column Storage Hanger,” filed Dec. 19, 2018, which is incorporated herein by reference in its entirety.

### BACKGROUND

High performance liquid chromatography (HPLC) and ultra-performance liquid chromatography (UPLC) are fundamental tools of analytical chemistry. In general, these are separation techniques that entail pumping a liquid analyte (the “mobile phase”) at high pressure through a typically tubular vessel (referred to as a “column”) filled with a material (referred to as the “stationary phase”) that impedes the flow of different components of the analyte to different degrees, so that some components of the analyte are delayed more than others in their flow through the column. Thus the outflow from the column contains different components of the analyte at different times, with the least delayed components emerging first and the more delayed components emerging later. The components can be separated simply by taking a sequence of samples from the outflow. This process is typically automated and managed by an HPLC instrument; these are available commercially from various manufacturers, typically as fairly large benchtop devices. (For brevity, as used herein, “HPLC” is intended to include any liquid chromatography modality entailing the use of removable columns, including without limitation UPLC.)

Different analytical tasks require columns of different sizes and/or packed with different stationary phase materials. HPLC instruments are typically designed to facilitate convenient replacement of columns so that the correct column for each analysis task can be easily installed into the mobile phase stream of the instrument. For most routine tasks, commercially available columns are used. These have the appearance of thin metal or glass tubes, a few mm in diameter, and ranging in length from about 30 to 250 mm. HPLC columns are often quite expensive, commonly costing as much as $1,000 or more for a single column, so they are reused whenever possible. When not in use, columns must be stored in a way that avoids damage and/or contamination.

In a larger scale analytical laboratory, there may typically be many HPLC instruments. Benchtop space is a scarce and valuable resource, not to be wasted on storage containers. Thus, a common practice is for HPLC columns to be stored in a shared, centrally located storage receptacle such as a box or drawer. This results in a very inefficient workflow, in which changing out an HPLC column entails disconnecting the column from the instrument, locating the correct caps or plugs with which to seal the ends of the column, leaving the bench to walk the column over to the central storage receptacle and deposit it there, searching the receptacle for the correct replacement column, searching for any required connectors, walking the replacement column back to the bench, removing the caps or plugs, and connecting the replacement column into the mobile phase stream of the instrument. Since the central storage receptacle will typically contain many columns of many different types disposed together, it is often necessary to withdraw columns one at a time to read the identifying information, typically printed in fine print along the exterior of the tube. Further time and effort may be wasted searching for the correct caps or plugs with which to seal the column being removed from the HPLC instrument, or for the various screws, nuts, connectors, or other accessories that may be needed to install the replacement column in the instrument. Other drawbacks of the boxes or drawers commonly used as storage receptacles are that they are of fixed size, so they have limited capacity and become more and more cluttered and less user-friendly as the number of stored columns increases; they take up scarce bench or drawer space; and the risk of expensive columns being dropped or damaged increases when columns must be frequently hand-carried away from the location where they are used.

Disclosed herein is an improved method and/or workflow for performing HPLC analysis, using a novel storage hanger for HPLC columns, avoiding the inefficiencies associated with the common practice of bulk storage of columns in a centralized shared receptacle, while optimally preserving valuable benchtop space.

### SUMMARY

In general, disclosed herein are embodiments of novel methods, systems, devices, apparatus, compositions, articles of manufacture, and improvements thereof useful for performing HPLC analysis and managing, storing, and handling the HPLC columns and their accessories used in such analysis.

In an aspect of the present disclosure there are provided various embodiments of a column storage hanger useful for storing chromatography columns, suspendable from an HPLC instrument without occupying benchtop space, in which may be disposed a plurality of HPLC columns of diverse dimensions in a manner allowing easy identification of column types, together with their associated hardware and accessories. In embodiments, an HPLC column storage hanger may include a backing composed of a flexible HPLC column-compatible material; a non-elastic retainer strip including a flexible, transparent and non-elastic HPLC column-compatible material disposed adjacent to the backing to form against the backing a plurality of approximately horizontally oriented chambers each open on both ends and each sized to permit insertion and passage of a single HPLC column, optionally with end caps installed; one or more elastic retainer strips composed of an elastic HPLC column-compatible material disposed adjacent to the backing to form a plurality of approximately horizontally oriented retaining loops each aligned with a chamber of the non-elastic retainer strip; and a suspension for suspending the HPLC column storage hanger from a support.

In another aspect of the present disclosure there are provided various embodiments of a workflow and/or method of performing liquid chromatography analysis which may include selecting and obtaining a chromatography column from an HPLC column storage hanger, installing the column into the mobile phase stream of an HPLC instrument, and operating the HPLC instrument to perform an HPLC analysis operation using the column.

In another aspect of the present disclosure there are provided embodiments of a system for performing HPLC analysis, which may include an HPLC instrument having a vertically oriented surface exposed and/or accessible to the exterior, a backing disposed against and/or adjacent to the vertically oriented surface, and a plurality of HPLC column retainers arrayed on the backing.

In embodiments, an object of the present disclosure is to improve the efficiency of HPLC workflows.

In embodiments, an object of the present disclosure is to provide convenient storage for columns at a location close to the location where the columns are used.

In embodiments, an object of the present disclosure is to reduce the risk of damage to and/or contamination of columns by reducing the need for handling and transport of columns.

In embodiments, an object of the present disclosure is to improve the efficiency and convenience of selecting columns for use by providing a storage modality in which the column bodies, and/or identifying information thereon, of multiple columns are visible simultaneously, and/or to obviate the necessity of manually extracting multiple columns from storage in order to locate a desired column.

In embodiments, an object of the present disclosure is to provide, in a column storage device, convenient storage for columns encompassing a wide diversity of lengths, diameters, weights, end hardware, and/or other characteristics.

In embodiments, an object of the present disclosure is to provide storage for end caps, adapters, and/or other hardware and/or accessories necessary or convenient for use with columns, accessible at the same location where columns are stored and in a manner whereby such items are visible for convenient selection.

In embodiments, an object of the present disclosure is to provide a column storage solution having the capability to accommodate relatively heavy columns without eventual failure due to loss of elasticity or other failure of support components.

In embodiments, an object of the present disclosure is to reduce the risk of damage to and/or contamination of columns by providing a column storage solution in which columns are kept physically separated one from another.

In embodiments, an object of the present disclosure is to reduce the risk of damage and/or contamination of columns by providing a column storage solution in which columns are in contact only with column-compatible materials.

In embodiments, an object of the present disclosure is to conserve scarce laboratory space by providing a column storage solution that does not occupy bench or drawer space.

In embodiments, an object of the present disclosure is to provide a column storage solution incorporating a form factor compatible for suspension adjacent to an HPLC instrument.

In embodiments, an object of the present disclosure is to provide a column storage solution including a convenient attachment for suspending the device from and/or adjacent to an HPLC instrument.

In embodiments, an object of the present disclosure is to provide a column storage solution capable of being collapsed into a compact form factor to allow convenient transport of a collection of columns stored therein.

In embodiments, an object of the present disclosure is to provide a column storage solution in which columns are securely held in position during storage and/or transport.

It will be apparent to persons of skill in the art that various of the foregoing aspects and/or objects, and various other aspects and/or objects disclosed herein, can be incorporated and/or achieved separately or combined in a single device, method, system, composition, article of manufacture, and/or improvement thereof, thus obtaining the benefit of more than one aspect and/or object, and that an embodiment may encompass none, one, or more than one but less than all of the aspects, objects, or features enumerated in the foregoing summary or otherwise disclosed herein. The disclosure hereof extends to all such combinations. In addition to the illustrative aspects, embodiments, objects, and features described above, further aspects, embodiments, objects, and features will become apparent by reference to the drawing figures and detailed description. Also disclosed herein are various embodiments of related methods, devices, apparatus, compositions, systems, articles of manufacture, and/or improvements thereof. The foregoing summary is intended to provide a brief introduction to the subject matter of this disclosure and does not in any way limit or circumscribe the scope of the invention(s) disclosed herein, which scope is defined by the claims currently appended or as they may be amended, and as interpreted by a skilled artisan in the light of the entire disclosure.

### BRIEF DESCRIPTION OF THE FIGURES

FIG. 1 shows a perspective view of an example embodiment of an HPLC column storage hanger consistent with the disclosure hereof.

FIG. 2 shows a perspective view of an example embodiment consistent with the disclosure hereof of an HPLC column storage hanger deployed adjacent to an HPLC instrument.

FIG. 3 shows a front elevation view of an example embodiment of an HPLC column storage hanger consistent with the disclosure hereof

FIG. 4 shows a left side elevation view of the example embodiment of an HPLC column storage hanger as depicted in FIG. 3.

FIG. 5A, FIG. 5B, and FIG. 5C show in cross-section alternative configurations of retainers in embodiments consistent with the disclosure hereof

FIG. 6 shows a front elevation view of another example embodiment of an HPLC column storage hanger consistent with the disclosure hereof

FIG. 7 shows a left side elevation view of an example embodiment of an HPLC column storage hanger as depicted in FIG. 5.

FIG. 8 shows a detail perspective view of an embodiment of a suspension for an HPLC column storage hanger consistent with the disclosure hereof.

Figures are not to scale unless expressly so labeled, and relative positions and orientations of objects and components are illustrative and not limiting except where expressly so stated. Persons of skill in the art will recognize that many other arrangements, configurations, dimensions, orientations, and selections of components are possible and consistent with the disclosure hereof, and are in no way limited to the embodiments shown in the figures.

### DETAILED DESCRIPTION

Disclosed herein are embodiments of methods, apparatus, compositions, systems, and articles of manufacture useful for performing HPLC analysis and managing, storing, and handling the HPLC columns and their accessories used in such analysis. Among other aspects, disclosed herein are embodiments of an HPLC column storage hanger and methods of carrying out an HPLC workflow including the use of an HPLC column storage hanger.

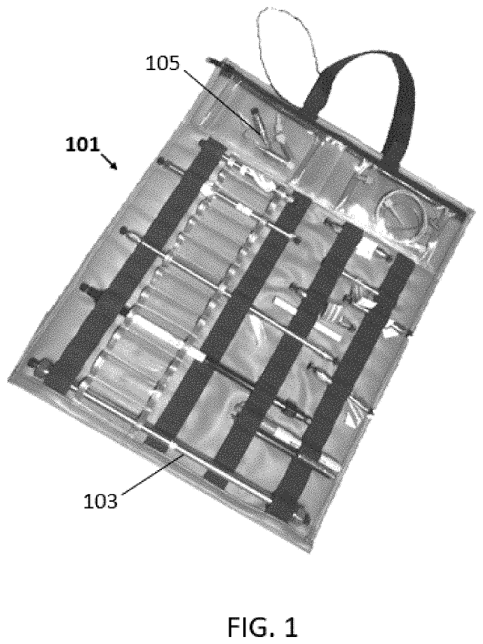

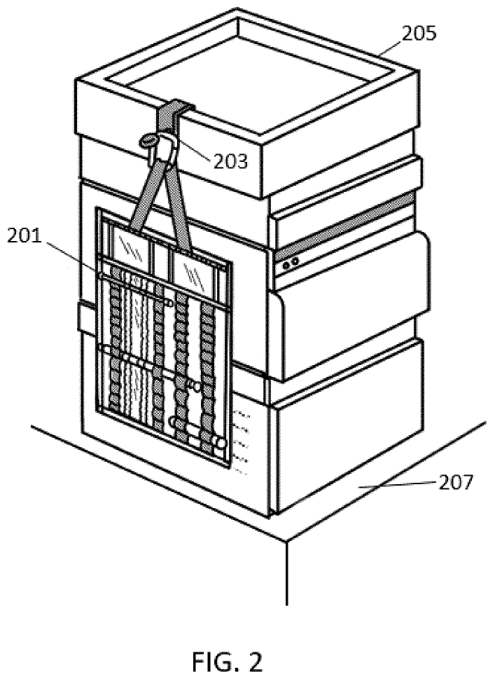

FIG. 1 depicts the overall layout and features of an exemplary embodiment of an HPLC column storage hanger 101, illustrating the manner in which a variety of columns 103 may be disposed therein together with various accessories 105 useful in handling and storing the columns and/or installing a column in the mobile phase stream of an HPLC instrument. As depicted in FIG. 2, in embodiments, an HPLC column storage hanger 201 may be adapted to be suspended 203 adjacent to an HPLC instrument 205 disposed on a laboratory bench 207.

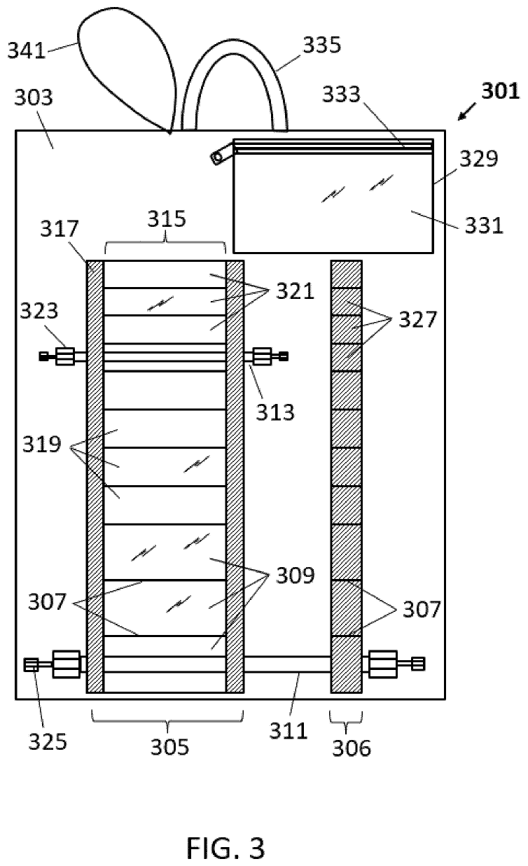

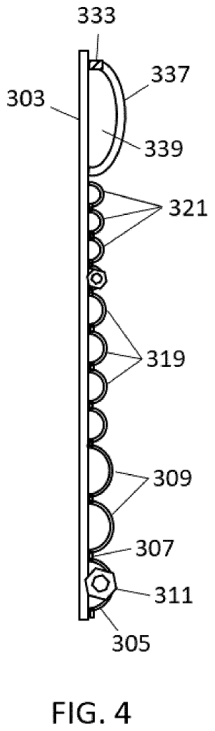

FIG. 3 and FIG. 4 depict front and left side views, respectively, of an embodiment of an HPLC column storage hanger 301, including a backing 303 on which a non-elastic retainer strip 305 is disposed and affixed in a series of adjacent horizontally oriented areas of contact 307 to form, together with the backing, a plurality of horizontally oriented chambers 309, 319, 321 each open at both ends and each sized to permit insertion and passage of a single HPLC column 311, 313 therein, as illustrated in side view in FIG. 4. In embodiments, the non-elastic retainer strip includes an HPLC column-compatible material that may preferably be transparent so that a portion of an HPLC column inserted in the chamber, and/or any identifying notation or features thereon, may be visible from the exterior. In embodiments, the non-elastic retainer strip may be composed in whole or part of a material resistant to fatigue and/or stretching under load during long-term use, capable of being stitched through or otherwise attached without tearing or failure, and having reasonable toughness to resist damage from insertion of and contact with columns. Examples of suitable materials may include clear vinyl and clear soft silicone, of a gauge and/or thickness providing weight-bearing capacity and damage resistance adequate for supporting columns of the kinds intended to be accommodated.

A material suitable for use in forming a non-elastic retainer strip could, in embodiments, include any non-elastic column-compatible material, which may preferably include a transparent material. In embodiments, a non-elastic retainer strip could be composed of more than one material in any combination found useful to provide desired strength, transparency, and/or other characteristics. For example, a non-elastic retainer strip could include a flexible non-elastic transparent material such as clear vinyl sheet extending over most of the width of the non-elastic retainer strip 315, which could be edged with a small width of non-transparent reinforcing material, such as, for example, woven tape 317, to provide further stability and resistance to edge damage, and for safety to prevent accidental cuts from sharp-edged retainer material

Chambers of a non-elastic retainer strip may be sized to provide openings and through-passages of size and cross-section operative to accommodate a column of desired width and geometry, optionally including column end hardware. In general, it may be found useful to size the chambers with large enough open cross-section to allow insertion of the ends 323 of the intended columns, which may be of larger diameter than their main tubular portion, and which may be fitted with end caps 325 or other connectors or accessories. It may also be found desirable to employ sizes no larger or only slightly larger than necessary to allow passage of the column ends, so that columns are reasonably confined against movement once placed in the storage hanger. In embodiments, a non-elastic retainer strip may include chambers of two, three, or more different widths, and/or having open cross-sections of two, three, or more different areas, to accommodate columns of diverse sizes and/or geometries. For example, as depicted in FIGS. 3 and 4, there could be provided one or more chambers 309 sized to accommodate relatively larger diameter columns, and one or more chambers 319 sized to accommodate columns of intermediate diameter, and one or more chambers 321 sized to accommodate columns of small diameter. In other embodiments there could be provided a plurality of chambers sized for large size columns (e.g. having a length from about 250 mm to about 300 mm and diameters of about 1 mm to about 15 mm), and a plurality of chambers sized for intermediate sized columns (e.g. lengths ranging from about 100 mm to about 250 mm and diameters of about 1 mm to about 15 mm), with small sized columns (e.g. lengths ranging from about 30 mm to about 100 mm and diameters of about 1 mm to 15 mm) being readily secured by one or more elastic retainer strips.

In embodiments, there may be provided an elastic retainer strip 306 disposed and affixed in a series of adjacent horizontally oriented lines of contact 307 to form against the backing a plurality of horizontally oriented retaining loops 327, each open in both lateral directions, each sized to permit insertion and passage of a single HPLC column, and each aligned with a chamber of the non-elastic retainer strip whereby a column inserted in a chamber of the non-elastic retainer strip could extend longitudinally through and be supported by a retaining loop of the elastic retainer strip. For an elastic retainer strip, it may be found useful to employ a column-compatible material that is flexible and elastic, to assist in holding relatively longer columns more securely. The novel use of a relatively wide, transparent, non-elastic retainer strip provides secure and convenient disposition of relatively large and heavy columns, which elastic loops alone would not be adequate to secure in place, particularly as the elastic material ages and loses strength and elasticity, while maintaining visibility of the column and/or any markings thereon. The novel combination of the non-elastic retainer strip with an elastic retainer strip allows for a longer column to be maintained in alignment and isolated from other columns, with the elastic retainer strip allowing for easy insertion of column ends and resistance to slippage due to the tighter grip maintainable by the elastic loops, and the non-elastic retainer strip providing support for the weight of the column.

In embodiments of an HPLC column storage hanger, it may be found useful to employ materials that are HPLC column-compatible, particularly as to materials that are in contact with or transmit forces to HPLC columns disposed in the storage hanger. A column-compatible material may include any material and/or combinations of materials which, when included as components of an HPLC column storage hanger in the intended manner, minimize or avoid damage to and/or contamination of the stored columns. Desirable characteristics of a column-compatible material may depend upon the component and its purpose, and may include, for example, imperviousness to contamination; imperviousness to moisture; softness; non-abrasiveness; durability; stability of shape; strength; and flexibility. Undesirable characteristics may include, for example, weakness, abrasiveness, unsuitability for stitching or adhesives, poor fatigue tolerance, poor durability, poor stain resistance, poor moisture resistance, and/or tendency to outgas or otherwise emit contaminants. Examples of materials suitable for various components of various embodiments of HPLC column storage hangers, indicating desirable characteristics, may be found in the accompanying Appendix.

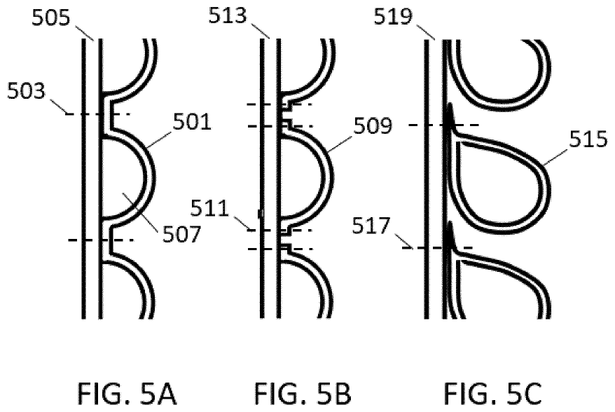

In embodiments, a retainer strip may be affixed to and/or disposed on a backing in any manner operative to provide chambers and/or retaining loops as disclosed herein; examples of affixation modalities could include sewing, riveting, welding, affixation using an adhesive, or any of the many other modalities known in the art for affixing materials one to the other. In embodiments as illustrated in FIG. 5A, it may be found useful to form a non-elastic retainer strip from a continuous sheet or strip of material 501 extending vertically to form two or more chambers by affixing the retainer portion material to the backing material at successive parallel lines of contact such as, for example, by stitching 503 the retainer portion material to the backing material 505 leaving excess retainer portion material to bulge outward to define an open chamber or loop 507. However, any other configuration operable to provide open ended chambers and/or retaining loops could be used, such as, for example, as depicted in FIG. 5B, forming each chamber and/or loop 509 separately from a single piece of non-elastic retainer material and stitching or otherwise attaching 511 each piece to a backing 513, or pre-forming retainer chambers and/or loops in tubular or closed-loop form 515 and affixing 517 these to a backing 519 as depicted in FIG. 5C. Similarly, an elastic retainer strip may be formed from a continuous strip of elastic material affixed to a backing with parallel rows of stitching or other affixation modality. In embodiments of elastic retainer strips, it may be unnecessary to form loops; the strips may be applied flat against the backing, with the elasticity of the strips allowing for insertion of columns between the elastic strip and the backing. As with the non-elastic retainer strip, it is also possible to form and or affix elastic retainer loops separately and/or individually rather than as a continuous strip.

In embodiments as depicted in FIG. 3 and FIG. 4, an HPLC column storage hanger may be provided with one or more pockets 329 such as for convenient storage of end caps, connectors, and/or other accessories associated with stored columns. A pocket may be constructed of any material or combination thereof, in any size and/or geometry, and using any mode of affixation to a backing or other portion of an HPLC column storage hanger, operable to contain the desired articles. In embodiments, a pocket may include a transparent material 331 whereby articles disposed in the pocket remain visible from the exterior. In embodiments, a pocket may have an opening through which articles may be placed within the pocket and/or removed. An opening may be provided with a closure, which could include any structure and/or component and/or portion thereof operable to close the opening in whole or part, such as, for example, a zipper 333, an interlocking groove and ridge closure, or a clamp-type closure. In embodiments as illustrated in FIG. 4, a pocket could include an outer portion 337 affixed at its edges to a to form a pocket 339 together with the backing 303, or a pre-formed bag or pocket, optionally including an opening provided with a closure, could be affixed to a backing, or a pocket could be formed and/or constructed and disposed in or on an HPLC storage hangar in any other manner operable to form a container for column-associated articles.

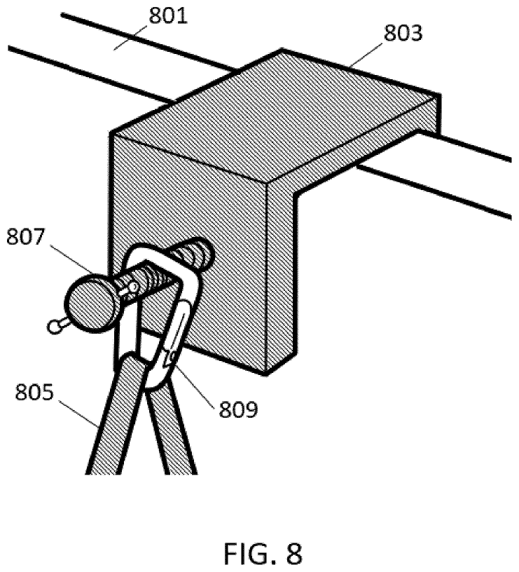

In embodiments, an HPLC column storage hanger may be provided with a handle 335, which may include any structure or component or combination thereof operable for suspending the HPLC column storage hanger from a support during use, such as, for example, as depicted in FIG. 2 and FIG. 8. A handle may also be adapted for grasping manually such as during transport.

In some embodiments, an HPLC column storage hanger may include a backing and retainer strips and other portions that are flexible, to allow the HPLC column storage hanger to be rolled or folded for compact storage and/or transport such as in a briefcase or suitcase. One or more components may be provided for securing the HPLC column storage hanger and its contents in a compact, rolled, folded, or collapsed configuration, such as, for example, an elastic loop 341 that can be secured around the hanger when rolled, or a belt with snap connector, or one or more cords or ties, or any other fastener(s) or combinations thereof operable to secure the storage hanger in a desired configuration. An advantage of the novel design disclosed herein is that columns are kept separated and protected by the column-compatible backing and retainer materials so as to avoid undue contact between columns, and consequent risk of damage, when the storage hanger is rolled or folded for transport.

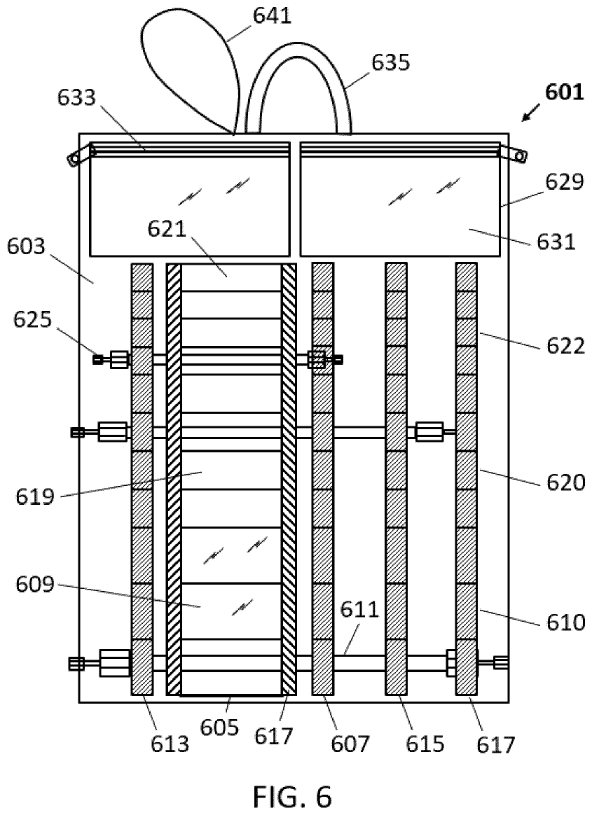

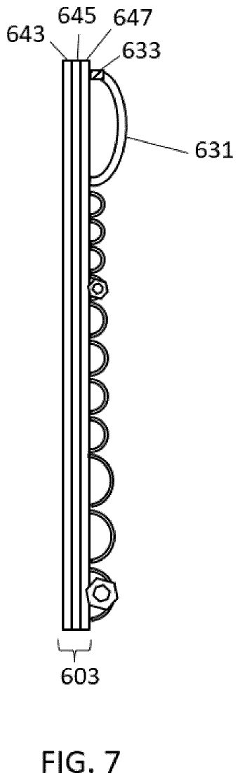

FIG. 6 and FIG. 7 depict front and left side views, respectively, of another embodiment of an HPLC column storage hanger 601, which may include one or more of a backing 603; a non-elastic retainer strip 605 which may include a transparent material and optionally be edged 617 with an edging material to provide additional strength and damage resistance; two, three, four, or more elastic retainer strips 613, 607, 615, 617; one, two, or more accessories pockets 629 which may include a transparent forward-facing material 631 and may include a closure 633; a handle 635; and an elastic loop 641 for securing the HPLC column storage hanger when rolled. The non-elastic retainer strip and elastic retainer strip(s) may define chambers and/or loops each sized for insertion of an HPLC column 625; two, three, or more chamber and/or loop sizes may be provided to accommodate columns of different sizes, such as, for example, chambers 609 and/or loops 610 of larger width such as, for example, about 3.5 cm to about 4.5 cm to accommodate larger HPLC columns, which could typically be inserted in and secured by a chamber of the non-elastic retainer strip and also by loops of one, two, or more of the elastic retainer strips; chambers 619 and/or loops 620 of intermediate width such as, for example, about 2.2 cm to about 3.5 cm to accommodate intermediate sized HPLC columns, which could typically be inserted in and secured by a chamber of the non-elastic retainer strip and optionally one of the elastic retainer strips; and chambers 621 and/or loops 622 of small width such as, for example, about 1.8 cm to about 2.5 cm to accommodate smaller sized HPLC columns, which could typically be inserted in and secured by a chamber of the non-elastic retainer strip alone, or by loops of one or two elastic retainer strips.

In embodiments, it may be found useful to employ, in a backing of an HPLC column storage hanger, a material including two, three, or more layers so as to take advantage of desired properties of more than one material. In some embodiments as depicted in FIG. 7, a backing could include an outer layer 643, a middle layer 645, and a column-adjacent layer 647. In an outer layer, it may be found useful to employ a barrier material. Desirable characteristics of a barrier material may include, for example, strength; durability; flexibility; resistance to misshaping, cracking, and/or fading; imperviousness to moisture and/or air; resistance to dust mites and fungus; resistance to high or low temperatures; stability without maintenance; and ease of cleaning. A barrier material could include any material providing a practicable combination of some or all of the foregoing characteristics. Examples of barrier materials suitable for use in a backing of an HPLC column storage hanger include leather; faux leather; vinyl leather; leatherette; water-impervious upholstery fabric; and vinyl, PVC, plastic-coated fiber materials such as Naugahyde™, and nylon fabric. In a middle layer of a backing of an HPLC column storage hanger, it may be found useful to employ a cushioning material. Desirable characteristics of a cushioning material may include, for example, compressibility; softness; pliability; stable restoration of shape under repeated compression; stability of properties over a range of temperatures; stability of compressive properties over time; and resistance to contamination. A cushioning material could include any material providing a practicable combination of some or all of the foregoing characteristics. Examples of cushioning materials suitable for use in a backing of an HPLC column storage hanger include compressed polyester, polyester fiber filled, polyurethane foam, Pelion™ foam, open cell foam, closed cell foam, fabric backed sew foam, memory foam, eggcrate foam, and foam cloth. In an inner and/or column-adjacent layer of a backing of an HPLC column storage hanger, it may be found useful to employ an HPLC column-compatible material. Materials used for a backing of an HPLC column storage hanger should preferably be compatible with the assembly and/or affixation modalities used; thus, for example, where components are affixed one to another by stitching, sewing machine-safe materials should be selected, and where components are affixed one to another by an adhesive, adhesive-compatible materials should be selected. In embodiments, use of a triple layer backing may provide advantages such as strength, flexibility, durability, safety, and pleasing aesthetics. In embodiments, a multi-layer backing may have edging material applied to the edges, such as to provide a more attractive edge, prevent fraying, protect users against sharp edges, or for any other purpose.

In embodiments as depicted generally in FIG. 2, an HPLC column storage hanger may be provided with a suspension 203 for suspending the HPLC column storage hanger from a support, such as, for example, an HPLC instrument 205. A suspension may include any structure, component, or combination thereof operable to secure an HPLC column storage hanger in a desired position providing access to columns stored therein. In embodiments, an HPLC column storage hanger provided with a handle may be hung or suspended by the handle from any suitable support. In embodiments as depicted in FIG. 8, it may be found useful to employ a suspension including a C-clamp and a snap link or carabiner, whereby the C-clamp 803 may be clamped to an upper surface or structure 801 of the case of an HPLC instrument, and the HPLC column storage hanger may be suspended by its handle 805 from the spindle 807 of the C-clamp using the snap link or carabiner 809. A carabiner could be suspended from the spindle of a C-claim either on the portion of the spindle adjacent to the support, or from the exterior portion of the spindle as shown in FIG. 8. In embodiments, it may be found preferable to suspend a carabiner or other suspension or portion thereof as close to the surface of an HPLC instrument as possible so that the HPLC column storage hanger will hang flat against the instrument.

An advantage of some embodiments of HPLC column storage hangers as disclosed herein is the substantially flat form factor, wherein the form factor is relatively large in lateral extent to accommodate columns of any commonly used length, large in vertical extent to accommodate simultaneously a number of columns commensurate with typical laboratory needs, and thin in depth to allow suspension adjacent to an HPLC instrument without interfering with other laboratory activities and to provide full visibility of all columns stored therein. In contrast to other commonly used storage modalities in which columns are stored in boxes or drawers in a manner whereby columns are stacked or otherwise hidden from view, in embodiments as disclosed herein, all the column storage positions may be arrayed in a single layer so that when the storage hanger is suspended for use each of the stored columns is visible and accessible without any need to disturb other columns. In embodiments wherein an HPLC column storage hanger is intended to be suspended adjacent to an HPLC instrument, it may be found useful to employ lateral and vertical dimensions somewhat smaller than the width and height, respectively, of the side of the HPLC instrument, so that the storage hanger does not extend beyond the edges of the HPLC instrument. For example, a width of about 33 to 40 cm and a height of about 40 to 50 cm will be found compatible with the dimensions of many commercial HPLC instruments.

Also disclosed herein are embodiments of a method and/or workflow for performing HPLC analysis, including obtaining an HPLC column from an HPLC column storage hanger, installing the HPLC column into the mobile phase stream of an HPLC instrument; and operating the HPLC instrument to perform an HPLC analysis operation using the HPLC column. In embodiments of a method, the column storage hanger may be suspended adjacent to the HPLC instrument in which the stored columns are to be used. This method provides greatly improved efficiency as contrasted with commonly used methods requiring the operator of an HPLC instrument to cross a busy and crowded lab space, search for a needed column, search for required connectors and/or accessories, and transport the column back across the lab space, doing this repeatedly each time a different column is needed.

Also provided herein is a system for performing HPLC analysis. In embodiments, a system for performing HPLC analysis may include an HPLC instrument and/or housing thereof having a generally vertically oriented surface exposed and/or accessible to the exterior, a backing according to the disclosure hereof and disposed against and/or adjacent to the vertically oriented surface, and a plurality of HPLC column retainers disposed on the backing, such as, for example, in a generally planar array. In embodiments, the backing may be suspended from the housing by a suspension which may include an attachable support, which could, for example, include a C-clamp and/or a carabiner. In embodiments, a system could include one or more HPLC columns disposed in one or more of the HPLC column retainers.

### EXAMPLE 1

A column storage hanger was constructed according to the general design and form factor depicted in FIGS. 1, 5 and 6. A triple-layer backing 38 cm in width and 46 cm in height (all dimensions are approximate) was prepared having an exterior layer of vinyl upholstery fabric, a middle layer of Flex-Foam™ 2-Sided Fusible lightweight two-sided fusible stabilizer, and a third (front) layer of Neo Signature™ fabric. The layers of the backing were assembled by sewing and an edging of nylon ribbon was applied to all four edges.

To the assembled backing was applied a non-elastic retainer strip by preparing an 8 cm wide strip of 12 gauge clear vinyl and affixing an edging of nylon ribbon. The vinyl strip was affixed to the backing with parallel horizontal lines of stitching as depicted generally in FIG. 5A. The vinyl is formed into a loop or corrugation while stitching so that the distance between parallel lines of stitching is smaller as measured along the backing material than as measured along the vinyl, so that after stitching the vinyl portion thus bulges out to form chambers through which columns may be inserted. The first five lines of stitching from the bottom were spaced about 3.8 cm apart along the backing to provide four chambers for inserting larger size columns, and the next 9 lines of stitching were placed about 2.5 cm apart to provide 9 chambers for accommodating smaller columns.

To the assembled backing were also applied four elastic retainer strips, in positions generally as depicted in FIGS. 6 and 7. Each of these was applied by stitching 2.5 cm width knitted non-roll elastic strap to the assembled backing with lines of stitching of the elastic retainer strips aligned with the lines of stitching of the non-elastic retainer strip, but without outward looping (which is not needed due to the elasticity of the material).

To the top portion of the assembled backing were also applied two 10 cm×19 cm clear vinyl zipper bags, generally in the positions as depicted in FIGS. 6 and 7. A handle of Dritz 2.5 cm Polypro belting and an elastic band for holding the storage hanger in a rolled configuration were affixed to the top portion of the assembled backing.

As depicted in FIG. 1, the upper nine retainer positions were found to conveniently accommodate HPLC columns of 100 mm, 150 mm, and 200 mm lengths, in either the transparent non-elastic retainer chambers or the elastic retainer loops. The lower four retainer positions were found to conveniently accommodate large HPLC columns of 250 mm and 300 mm lengths, inserted through the transparent non-elastic retainer strip and also through at least one of the elastic retainer strips. The combination of the strong, non-elastic retainer with the elastic additional retainers was found to secure even relatively heavy columns without sagging or shifting, both in the working configuration wherein the storage hanger is open and suspended vertically, and in the transport configuration wherein the storage hanger is rolled or folded.

### Concluding Matter

As used herein, “column” may refer to any vessel or container used or usable to contain a stationary phase material through which a mobile phase analyte is made to flow as part of a liquid chromatography analysis. Columns commonly take the form of metal tubes, open on both ends, and provided with connectors on both ends to allow the columns to be easily connected to the flow

As used herein, “HPLC instrument” may extend to any chromatography instrument using columns capable of being removed, reused, replaced, and/or switched out with other columns. “HPLC”, when used as an adjective, is intended to include UPLC and any other chromatography modality involving columns capable of being removed, reused, replaced, and/or switched out with other columns.

The disclosed methods, systems, devices, apparatus, compositions, articles of manufacture, and improvements thereof have been explained above with reference to several embodiments. Other embodiments will be apparent to those skilled in the art in light of this disclosure. Certain aspects of the described subject matter may readily be implemented using configurations other than those described in the embodiments above, or in conjunction with elements other than those described above. For example, different components may be used.

Further, it should also be appreciated that the described subject matter can be implemented in numerous ways, including as a process, an apparatus, or a system. Any of the methods of the present disclosure may be carried out using any of the disclosed devices or apparatus according to any aspect or embodiment of the present invention, or in any other operable manner, in any operable combination. The order of the steps of the methods described herein may be altered and still be within the scope of the disclosure.

In the foregoing disclosure, specific functions may be attributed to specific components or modules. It will be apparent that the functional boundaries between components or modules are substantially artificial; functionality attributed to two or more modules or components could equivalently be combined in a single module or component, and functionality attributed to a single module or component could equivalently be distributed among two or more modules or components. In embodiments, such functions and their associated modules and/or components may be disposed in a single physical unit or housed in two or more physically separate units. The disclosure hereof extends to all such equivalent arrangements.

Except as otherwise explicitly stated, an embodiment of an apparatus or object is described herein in an orientation as in normal use as described herein, with “lower side” referring to the portion generally oriented downward, and “upper side” referring to the generally upwardly oriented portion. “Upward” and “downward” refer to the upward and downward directions relative to the apparatus or object when oriented generally as illustrated in the drawing figures. “Lateral” and “horizontal” refer to the spatial dimensions generally perpendicular to the “upward” and “downward” directions, with the apparatus or object oriented generally as illustrated in the drawing figures. “Vertical” refers to the generally upward/downward direction with the apparatus or object oriented as illustrated in the drawing figures. “Inward” and “outward” refer respectively to lateral directions generally toward and away from a generally vertical axis passing through the centroid or center of mass of the apparatus or object. “Front” and “rear” refer respectively to portions of an object facing generally toward or away from a user in normal use of the object as disclosed herein. “Left” and “right” refer respectively to the left or right portions of an object when viewed from the front. The foregoing directional and/or orientation terms are employed for convenience so as not to overly complicate the description. The objects described may be positioned in any orientation operable for an application of interest. Except as otherwise specifically stated or required by context, directional terms are not intended to be limiting or to imply that the apparatus or object must be used in any particular position or orientation.

In embodiments, components and/or substructures described herein as having fixed positions relative one to another may be held in position in any manner operable to maintain the specified positions under conditions of normal use as described herein, such as, by way of example only, by the use of mechanical fasteners such as bolts, screws, nuts, rivets, or stitching; by heat, such as, for example, welding, brazing, or soldering; by an adhesive; by incremental deposition, such as, for example, by 3D printing; and/or by forming a component integrally or as a single piece with another component. In embodiments, components and/or substructures described herein as having movable positions relative one to another may be constrained in position in any manner operable to constrain the components and/or substructures within the specified ranges of positions under conditions of normal use as described herein, such as, by way of example only, by the use of mechanical fasteners such as hinges, sliders, tracks, followers, pivots, bearings, and/or flexible components. Unless otherwise specifically stated or required by context, mounting and/or affixation may be permanent or removable or removable and replaceable, as deemed useful for an application of interest.

For clarity and to ensure completeness, certain of the aspects and/or embodiments disclosed herein may be overlapping in scope, described repetitively, or represent recitals of the same or equivalent elements or combinations expressed in alternative language. It will be apparent that the choice of particular phraseology and/or of particular aspects or elements to assert as claims involves many complex technical and legal considerations, and no inference should be drawn that alternative descriptions of a particular element or combination in this written description necessarily do or do not encompass different subject matter; except where context otherwise requires, each described aspect or element should be interpreted according to its own description.

It is intended that this specification be interpreted in accordance with the normal principles of English grammar and that words and phrases be given their ordinary English meaning as understood by persons of skill in the pertinent arts except as otherwise explicitly stated. If a word, term, or phrase is intended to be further characterized, specified, or narrowed in some way, then additional adjectives, modifiers, or descriptive text have been included in accordance with the normal principles of English grammar. It is intended that the meanings of words, terms, or phrases should not be modified or characterized in a manner differing from their ordinary English meaning as understood by persons of skill in the relevant arts except on the basis of adjectives, modifiers, or descriptive text that is explicitly present.

Except as otherwise explicitly stated, terms used in this specification, including terms used in the claims and drawing figures, are intended as “open” terms. That is, for example, the words “including” and “comprising” should be interpreted to mean “including but not limited to,” the word “having” should be interpreted to mean “having at least,” the word “includes” should be interpreted to mean “includes but is not limited to,” the phrases “for example” or “including by way of example” should be interpreted as signifying that the example(s) given are non-exhaustive and other examples could be given, and other similar words and phrases should be given similar non-exclusive meanings. Except as explicitly stated, ordinals used as adjectives (e.g. “first object”, “second object”, etc.) in this specification, including claims and drawing figures, are intended merely to differentiate and do not imply that any particular ordering is required. Thus, for example, unless otherwise explicitly stated, “first measurement” and “second measurement” do not imply that the first measurement necessarily takes place before the second measurement, but merely that they are distinct measurements.

In the written description and appended claims, the indefinite articles “a” and/or “an” are intended to mean “at least one” or “one or more” except where expressly stated otherwise or where the enabling disclosure requires otherwise. The word “or” as used herein is intended to mean “and/or”, except where it is expressly accompanied by the word “either”, as in “either A or B”. Applicants are aware of the provisions of 35 U.S.C. § 112(f). The use of the words “function,” “means” or “step” in the written description, drawings, or claims herein is not intended to invoke the provisions of 35 U.S.C. § 112(f), to define the invention. To the contrary, if the provisions of 35 U.S.C. § 112(f) are sought to be invoked, the claims will expressly include one of the exact phrases “means for performing the function of” or “step for performing the function of”. Moreover, even if the provisions of 35 U.S.C. § 112(f) are explicitly invoked to define a claimed invention, it is intended that the claims not be limited only to the specific structure, material or acts that are described in the preferred embodiments, but in addition, extend to any and all structures, materials or acts that perform the claimed function as described in alternative embodiments or forms of the invention, or that are well known present or later-developed equivalent structures, material or acts for performing the claimed function.

In the foregoing description, various details, specific aspects, embodiments, and examples have been described in order to illustrate and explain the subject matter, to provide a thorough understanding of the various aspects, to enable persons skilled in the pertinent arts to practice the described subject matter, and to disclose the best mode of doing so known to applicants. These details, specific aspects, embodiments, and examples are not intended to be limiting; rather, it will be apparent to persons of skill in the relevant arts that, based upon the teachings herein, various changes, substitutions, modifications, rearrangements, may be made and various aspects, components, or steps may be omitted or added, without departing from the subject matter described herein and its broader aspects. Except as otherwise expressly stated or where aspects or features are inherently mutually exclusive, aspects and features of any embodiment described herein may be combined with aspects and features of any one or more other embodiments. Titles, headings, and subheadings herein and the abstract hereof are intended merely as a convenience for indicating the general nature of subject matter, and do not limit or otherwise affect the interpretation of the content of the disclosure. The appended claims are intended to encompass within their scope any and all changes, substitutions, modifications, rearrangements, combinations of aspects or features, additions, and omissions that are within the spirit and scope of the subject matter as described herein and/or within the knowledge of a person of skill in the art. The scope of the invention is defined by the claims and is not limited by or to the particular embodiments or aspects chosen for detailed exposition in the foregoing description, but rather extends to all embodiments or aspects as defined by the claims, as well as any equivalents of such embodiments or aspects, whether currently known or developed in the future.

This disclosure is accompanied by an Appendix, which is incorporated herein by this reference.

We claim:

1. A high performance liquid chromatography (HPLC) column storage hanger, comprising:
a backing comprising a flexible HPLC column-compatible material;
a non-elastic retainer strip comprising a flexible, transparent and non-elastic HPLC column-compatible material disposed adjacent to the backing to form a plurality of approximately horizontally oriented chambers each open on both ends and each sized to permit insertion and passage of a single HPLC column;
a first elastic retainer strip comprising an elastic HPLC column-compatible material disposed adjacent to the backing to form a plurality of approximately horizontally oriented retaining loops each aligned with a chamber of the non-elastic retainer strip; and
a suspension for suspending the HPLC column storage hanger from a support.

2. The HPLC column storage hanger of claim 1, further comprising at least one HPLC column extending through a chamber of the non-elastic retainer strip and through a retaining loop of the first elastic retainer strip.

3. The HPLC column storage hanger of claim 1, wherein at least two of the chambers of the non-elastic retainer strip are sized to permit insertion and passage of HPLC columns of different diameters.

4. The HPLC column storage hanger of claim 1, further comprising a second elastic retainer strip comprising an elastic HPLC column-compatible material disposed adjacent to the backing and parallel to the non-elastic retainer strip on the side of the non-elastic retainer strip opposite from the first elastic retainer strip, to form a plurality of approximately horizontally oriented retaining loops each aligned with a chamber of the non-elastic retainer strip.

5. The HPLC column storage hanger of claim 1, further comprising third and fourth retainer strips each comprising elastic HPLC column-compatible material disposed adjacent to the backing and parallel to the non-elastic retainer strip to the same side of the non-elastic retainer strip as the first elastic retainer strip, each forming a plurality of approximately horizontally oriented retaining loops with each retaining loop aligned with a chamber of the non-elastic retainer strip.

6. The HPLC column storage hanger of claim 1, further comprising at least one accessories pocket, wherein the accessories pocket comprises a closure and the outwardly facing portion of the accessories pocket comprises a transparent material whereby at least a portion of the interior of the accessories pocket is visible from the exterior.

7. The HPLC column storage hanger of claim 1, wherein the backing comprises a layer of cushioning material disposed between a layer of barrier material and a layer of column-compatible fabric.

8. The HPLC column storage hanger of claim 1, wherein all column storage positions therein are arrayed in a single layer.

9. The HPLC column storage hanger of claim 1, wherein the backing and retainer strips comprise flexible materials whereby the HPLC column storage hanger is rollable or foldable.

10. The HPLC column storage hanger of claim 1, wherein the suspension comprises a C-clamp and a carabiner.

11. A method of performing HPLC analysis, comprising:
from a HPLC column storage hanger according to claim 1, selecting an HPLC column stored therein;
removing the selected HPLC column from the HPLC storage hanger;
installing the HPLC column into the mobile phase stream of an HPLC instrument; and
operating the HPLC instrument to perform an HPLC analysis operation using the HPLC column.

12. The method of claim 11, wherein the HPLC column storage hanger is suspended from and adjacent to the HPLC instrument.

13. A system for performing HPLC analysis, comprising:
an HPLC instrument comprising a vertically oriented surface exposed to the exterior;
a backing disposed against the vertically oriented surface;
a plurality of HPLC column retainers disposed in a generally planar array on the backing.

14. The system of claim 13, wherein the backing is suspended from the housing by a suspension comprising an attachable support.

15. The system of claim 14, wherein the attachable support comprises a C-clamp and a carabiner.

16. The system of claim 13, further comprising at least one HPLC column disposed in an HPLC column retainer.
